(19) United States
(12) Patent Application Publication
(10) Pub. No.: US 2021/0215236 A1
(43) Pub. Date: Jul. 15, 2021

(54) LINEAR ACTUATOR FOR A FURNITURE SYSTEM, ELECTRICALLY ADJUSTABLE FURNITURE SYSTEM, METHOD FOR MOUNTING A LINEAR ACTUATOR IN A FURNITURE SYSTEM AND FURNITURE SYSTEM ARRANGEMENT

(71) Applicant: LOGICDATA Electronic & Software Entwicklungs GmbH, Deutschlandsberg (AT)

(72) Inventor: Stefan LUKAS, Preding (AT)

(21) Appl. No.: 16/963,812

(22) PCT Filed: Jan. 16, 2019
(86) PCT No.: PCT/EP2019/051069

§ 371 Date: Mar. 26, 2021

(30) Foreign Application Priority Data
Jan. 22, 2018 (DE) 10 2018 101 330.2

(51) Int. Cl. F16H 25/20; A47C 3/24; A47B 9/20; A47B 9/04; A47C 3/40; A47C 1/024; A47C 20/04; A47C 19/04; H02K 7/06; H02K 21/24

(52) U.S. Cl. CPC F16H 25/20; F16H 2025/2075; A47B 9/20; A47B 9/04; A47C 3/40; A47C 1/0242; A47C 20/041; A47C 20/042; A47C 1/0246; A47C 19/04; H02K 7/06; H02K 21/24; A47B 2200/0059; A47B 2200/0061; A47C 3/24

(57) ABSTRACT

A linear actuator for a furniture system comprises at least one axial flux motor (5) having a rotor (9), and at least one motion mechanism (6) attached to the rotor (9). The motion mechanism (6) is adapted to cause a linear movement of the linear actuator.

An electrically adjustable furniture system comprises at least one such linear actuator. A furniture system arrangement comprises at least one first and at least one second such electrically adjustable furniture system. A method of installing a linear actuator in a furniture system comprises the steps mounting at least one axial flux motor (5), mounting at least one motion mechanism (6), and connecting the at least one motion mechanism (6) to a rotor (9) of the at least one axial flux motor (5).

### BACKGROUND OF THE INVENTION

The present application concerns a linear actuator for a furniture system. The application further relates to an electrically adjustable furniture system, in particular a table system, a seating furniture or a bed system, comprising at least one such linear actuator, a method of installing such a linear actuator in such a furniture system and a furniture system arrangement comprising at least one first and at least one second such electrically adjustable furniture system.

Electrically adjustable furniture systems, for example table systems, seating furniture or bed systems, use linear actuators to adjust, for example, a height or an angle of inclination of individual parts of the furniture system. Such linear actuators usually comprise an electric motor and a gear unit that drives a motion mechanism of the linear actuator. The motion mechanism generates a linear movement of the linear actuator from a rotational movement of the electric motor.

A disturbing feature of conventional linear actuators for furniture systems is often a considerable noise emission when the linear actuator is actuated. Another disadvantage of conventional linear actuators for furniture systems is the relatively large design of such linear actuators, the linear actuators consisting of the electric motor, the gear unit and the motion mechanism.

### SUMMARY OF THE INVENTION

An embodiment of a linear actuator for an electrically adjustable furniture system comprises, for example, at least one axial flux motor having a rotor and at least one motion mechanism mounted on the rotor, the motion mechanism being adapted to cause a linear movement of the linear actuator.

The motion mechanism comprises for example a spindle connected to the rotor. The spindle is rotatably mounted in a nut so that rotational movement of the rotor moves the spindle relative to the nut along a longitudinal axis of the spindle. The rotational movement of the rotor is caused, for example, by a rotating magnetic field generated by a stator of the axial flux motor in interaction with permanent magnets mounted on the rotor. Alternatively to the motion mechanism described here, however, any motion mechanism for the linear actuator described here is conceivable, which converts the rotary movement of the axial flux motor into a linear movement of the linear actuator.

A torque which needs to be applied to actuate the motion mechanism of the furniture system is approximately 0.75 Newton meters. The torque generated by the axial flux motor is cubically proportional to a radius of the rotor of the axial flux motor. The axial flux motor generates a torque that is sufficient to directly drive the motion mechanism of the linear actuator. Therefore, it is not necessary to use a gear unit between the axial flux motor and the motion mechanism. The design of the linear actuator described here enables a high ratio between the generated torque and the weight of the linear actuator.

Since no gear unit is used in the linear actuator described here, low rotational speeds of the axial flux motor is sufficient for extending or retracting the motion mechanism. For the linear actuator described here, rotational speeds of the axial flux motor in a range from 500 to 2000, especially up to 1500, revolutions per minute are used. For example, the axial flux motor is operated at a rotational speed of approximately 1000 revolutions per minute. Such speeds are advantageous because they limit the amount of torque to be generated by the axial flux motor, and thus limit a size of the axial flux motor. This allows flexible installation of the axial flux motor

On the other hand, compared to actuators driven at higher rotational speeds, wear of mechanical parts is reduced and exceeding a maximum speed of adjustment is prevented this way.

As disturbing noise emissions are generated in conventional linear actuators especially by high rotational speeds of the electric motors and by movements of mechanically moving parts in a gear unit, the linear actuator described here with axial flux motor and without gear unit generates considerably lower noise emissions. The low rotational speeds also contribute to the fact that any remaining noise emissions produce a sound that is less disturbing to the human ear, since the human ear usually perceives high-frequency sounds as more disturbing than sounds with a low frequency.

According to one example, the spindle of the motion mechanism has an external thread with a thread pitch of less than 5 millimeters per revolution. In this case, the spindle is moved relative to the nut along the longitudinal axis of the spindle by less than 5 millimeters once the spindle has been rotated 360° in the nut. The advantage of a thread pitch of less than 5 millimeters is that sufficient self-locking is generated by the spindle in the nut to prevent the spindle from slipping when the axial flux motor stops. It is therefore possible to forgo additional braking mechanisms, which ensures a simpler, lighter and cheaper design of the linear actuator.

Another advantage of the linear actuator described here is that the axial flux motor has a much smaller expansion perpendicular to a plane of rotation of the rotor compared to conventional electric motors. The lower height of the axial flux motor contributes to the fact that a larger stroke can be achieved with the linear actuator described here with the same height expansion of the entire linear actuator, since the axial flux motor requires less height of the linear actuator, which is thus available for the motion mechanism. In other words, the axial flux motor has a flat, disc-shaped structure with a low installation height.

Another advantage of the linear actuator with an axial flux motor described here is that the axial flux motor has a slower start-up and smoother running than a conventional electric motor. The rotor of the axial flux motor has a larger radius compared to the electric motors of conventional linear actuators. According to one example, the rotor has a diameter of up to 120 mm. The rotor thus acts as a flywheel in the axial flux motor and enables the rotor to run smoothly and evenly. This helps, for example, to ensure that the motion mechanism of the linear actuator is moved gently and, for example, that the rotor runs more smoothly in a bearing provided for the rotor, thus minimizing wear on the motion mechanism and the bearings.

Furthermore, it is advantageous that the design of the linear actuator without gear units allows a cost-effective production. The low weight of axial flux motors also contributes to the fact that the linear actuator can be produced more cheaply and that shipping costs of the linear actuators and transport costs of the entire furniture systems can be reduced.

The design of the linear actuator without gear units also allows higher duty cycles compared to conventional linear actuators where the duty cycles are limited by a gear unit.

Another advantage of the high torque of the axial flux motor is that, compared to other direct drives, no permanent magnets with rare earth elements need to be used for the axial flux motor. In other direct drives, high torques, which are required for adjusting the furniture system, can only be achieved with permanent magnets that are, for example, at least partially made of neodymium-iron-boron. The extraction of rare earths is often costly and associated with considerable environmental destruction.

According to one example, the axial flux motor is set up to be supplied with a voltage rectified from a mains voltage, in particular from a mains voltage of 230 Volts or 115 Volts. For such an operation, thin wires and high numbers of windings are used for windings on pole pieces of a stator of the axial flux motor, which generate a magnetic field in the axial flux motor. The mains voltage is taken from a supply network, rectified with a rectifier and connected directly to the windings from an output of the rectifier, for example via a commutator circuit. The pole pieces with the wound wires represent electromagnets which generate the magnetic field. The axial flux motor is constructed in such a way that the wires of the electromagnets are wound exclusively linearly on the stator. These comparatively simple windings can be produced with linear winders.

The use of a rectified mains voltage also makes it possible to use a small power supply unit, which essentially consists of a rectifier circuit. More complex circuits, for example with a transformer, are not used in this case. This contributes to the fact that a higher efficiency can be achieved with such power supplies. In addition, it is thus possible to supply the linear actuator directly and without potential separation through transformers or switching power supplies from the voltage network in a simple way. Furthermore, such a power supply unit provides more power from the voltage network, as there is no need for a transformer or a switching power supply unit. A power limitation by the power supply unit is thus avoided or at least minimized.

The axial flux motor has a stator, with a plane of rotation of the rotor parallel to a main plane of extension of the stator. The main plane of extension of the stator corresponds to the plane in which the electromagnets are arranged. In this case, the stator and rotor form a stacked structure. The stator does not surround the rotor, not even partially, as in conventional electric motors. In such a structure, the magnetic field lines of the magnetic field generated by the stator are perpendicular to a plane of rotation of the rotor and parallel to an axis of the rotor at a point where the magnetic field lines meet the rotor.

According to one example, power electronics and/or control electronics of the at least one axial flux motor are arranged on the at least one stator. Since the stator has a larger extension parallel to the plane of rotation of the rotor, i.e. in the main plane of extension of the stator, than perpendicular to the plane of rotation of the rotor, an arrangement of the power electronics and/or the control electronics on a side of the stator facing away from the rotor is advantageous, since this contributes to a compact design of the linear actuator. The power electronics are designed to supply the electromagnets of the stator with a mains voltage. The control electronics are set up to switch the mains voltage applied to the electromagnets according to a control signal from a control unit.

According to one example, a design of the at least one axial flux motor is selected such that a torque ripple of the at least one axial flux motor prevents slipping of the linear actuator. The torque ripple depends essentially on the geometry of the motor. Air gaps are located between the electromagnets of the stator. If the electromagnets are not supplied with current, the rotor will always adjust itself so that the permanent magnets of the rotor are as close as possible to the switched-off electromagnets, i.e. the permanent magnets are aligned in such a way that they face the electromagnets in the best possible way. The permanent magnets are not aligned with the air gaps between the electromagnets.

If the rotor starts rotating from this stable position, force must be applied until the permanent magnets are approximately in the middle of a respective air gap. This force represents a braking force that prevents a slipping of a linear actuator at standstill. For example, by selecting the size of the air gaps, this braking force and thus the torque ripple can be adjusted so that it is greater than a force exerted on the motion mechanism by a weight force of an adjustable part of the furniture system. In this way, additional devices for braking or holding the linear actuator at a standstill can be forgone.

When the electromagnets of the stator are supplied with current, the electromagnets generate a rotating magnetic field, which the rotor follows. The rotor must then again be pulled across the air gaps. The torque generated by the electric motor thus fluctuates. In combination with a corresponding load on the adjustable part of the furniture system, this leads to a jerky adjustment of the adjustable part of the furniture system.

With a suitable control it is possible to apply a three-phase alternating current to the electromagnets of the stator to generate the rotating magnetic field in such a way that a stronger rotating magnetic field is generated when the rotor is pulled across the air gap to keep the torque at a constant level.

According to one example, the stator, in particular the individual parts of the stator, such as a support plate and/or pole pieces, are formed from a solid material which is made of iron or an iron alloy and which has eddy current properties which are set up to extract energy, in particular braking energy, from the at least one axial flux motor.

For example, the solid material has an electrical conductivity greater than 2 MS/m, in particular greater than 10 MS/m. As a material, for example, a mild steel can be used, which is generally less expensive than special layered materials. Mild steel can have an electrical conductivity of approximately 10.5 MS/m.

The choice of the material as a solid material and especially as a material with special eddy current properties results in higher iron losses during operation of the axial flux motor than if the stator is formed with stacked and/or insulated sheets with the lowest possible conductivity, as is usually used in electric motors. As a result, the axial flux motor develops a braking effect under load, which in turn acts as a braking force to prevent slipping of an especially stationary linear actuator. However, slipping during a downward movement, i.e. in the direction of an applied external load, can also be prevented or reduced by the braking effect.

According to one example, the axial flux motor has a motor housing which comprises an upper motor cover, a lower motor cover and an insert. The insert has a continuous inner ring and an outer ring connected to the inner ring via bridges and interrupted several times. The insert further has receiving areas for stator teeth, and the inner ring has at least two bearing points for receiving bearings for the motor shaft. The insert is designed to transmit a force from a motor shaft to mounting points on the motor housing.

The receiving areas are open to one side, for example. The receiving areas are not closed. On the one hand, this reduces the total weight of the insert and thus of the motor housing of the axial flux motor and, on the other hand, enables simple and quick insertion of the stator teeth into the receiving areas when assembling the axial flux motor.

According to one example, the insert comprises or consists of a metallic material. The upper and lower motor covers comprise or consist of a plastic material. An advantage of this is that the insert increases the stiffness and stability of the axial flux motor, while the motor housing has a low total weight due to the plastic material used.

According to one example, an electrically adjustable furniture system, in particular a table system, a seating furniture or a bed system, includes at least one linear actuator according to one of the examples described above.

According to one example, the electrically adjustable furniture system further comprises at least one mount for a substantially horizontally arranged plate and at least one telescopic column arranged substantially perpendicular to the plate, the telescopic column having a foot part. The at least one axial flux motor is arranged on the plate or in the foot part such that a plane of rotation of the rotor is parallel to the plate. The at least one motion mechanism is arranged in the at least one telescopic column.

The essentially horizontally arranged plate is, for example, a table top of a table system or a seat of a piece of seating furniture. The disk-like construction of the axial flux motor is particularly suitable for installation on the top or in the foot part.

The arrangement of the at least one axial flux motor on the plate or in the foot part contributes to the fact that a larger stroke can be achieved with the linear actuator than with a linear actuator in which a motor and/or gear unit is arranged in a telescopic column. Since the at least one motion mechanism is arranged in the at least one telescopic column, the entire area of the telescopic column can be optimally used for the motion mechanism.

According to one example, the axial flux motor has a maximum height of 40 millimeters in a direction perpendicular to the plane of rotation, respectively along an axis of rotation of the rotor.

According to one example, the furniture system further comprises at least one manual switch and at least one control unit, wherein the at least one manual switch is adapted to send an actuation signal to the at least one control unit upon actuation of the manual switch by a user, and the at least one control unit is adapted to send a control signal to the at least one linear actuator based on the at least one actuation signal.

Such a control unit is for example a central control unit which receives an actuation signal from the at least one manual switch via an interface between the manual switch and the control unit and sends control signals based on the actuation signal to the corresponding linear actuators via at least one further interface between the control unit and the corresponding linear actuators. In this configuration, the control unit and manual switch are arranged, for example, in a common housing. The manual switch and the control unit can also be connected to each other wirelessly or via cables. The linear actuators and the control unit are connected by cables.

Alternatively, the control is a decentralized control consisting of several control units, each of which is directly connected to at least one linear actuator. In this case the at least one manual switch sends the actuation signal to at least one of the decentralized control units when actuated by a user. The corresponding decentralized control nits then control the respective linear actuators based on the actuation signal.

A configuration with such decentralized control units is designed as a master-slave control, for example. In this case there are additional interfaces between the decentralized control units. Via these additional interfaces, information is transmitted between control units which is triggered by an actuation signal. This information usually represents a sequence of data triggered by the actuation signal. Such a master-slave control system is thus characterized by several decentralized control units which communicate with each other and wherein each control unit controls at least one linear actuator. The decentralized control units either have each their own housing or are installed in a housing of the respective linear actuator. In master-slave control, there are several control units, with one control unit acting as master and the other control units representing its slaves.

According to one example of the master-slave control, the decentralized control units each have their own housing. According to another example of the master-slave control, the control units do not have their own housing. Instead, the control units are arranged within the housing of each individual linear actuator. Accordingly, each linear actuator has its own control unit.

The control units communicate with each other. For example, the manual switch is connected to one of the control units. In addition, further manual switches can be connected to further control units. If the system is operated with one of the manual switches, then the control unit connected to the manual switch acts as the master and the other control units as slaves. If a button on the manual switch is pressed, the manual switch communicates this information to the master. On the one hand, the master reacts by accordingly controlling the linear actuators directly connected to the master and, on the other hand, by informing its slaves that they should control their associated linear actuators accordingly.

The information from the manual switch is passed on, for example, by simply forwarding the unchanged actuation signal or by the master sending a sequence of other commands to the slaves from the actuation signal. This data exchange is described by a protocol. For example, a protocol is used for synchronous movement of linear actuators. This is characterized by the fact that the slaves supply information to the master for synchronization. In an alternative protocol, such information is not sent from the slaves to the master. The slave control units then only receive target settings from the master and adjust the corresponding linear actuators quasi-parallel to each other.

According to one advantageous example, the at least one control unit of the electrically adjustable furniture system comprises a network module and a control module, the network module being adapted to communicate with other network modules via the wireless network and the control module being adapted to send the control signal to the at least one linear actuator. Network module and control module are for example arranged on a common printed circuit board in the housing of the control unit and are electronically connected to each other. Via the network module, the control units communicate with each other and/or with the at least one manual switch. The control module includes for example the power electronics and the control electronics. The control module comprises technical control tasks and generates the control signals for the linear actuators and sends them via cable to one or more linear actuators.

Optionally, the at least one manual switch and/or the at least one control unit is set up to carry out communication between the manual switch and at least one control unit and/or communication between the at least one control unit and at least one further control unit via a wireless network.

Such an arrangement is particularly advantageous if the at least one linear actuator and/or the at least one control unit is supplied with a rectified mains voltage, in particular 230 V or 115 V.

The challenge with such an arrangement is that protective measures are required to prevent contact with voltage carrying parts. Communication via the wireless network thus makes it possible to minimize the number of voltage carrying parts, especially minimizing cables with high mains voltage. In particular, a radio-based, battery-operated manual switch can also be used for such an arrangement. A suitable wireless network here is a Bluetooth network or a wireless local area network (WLAN), for example. Every component that communicates within the furniture system via the wireless network is referred to as a network node. Such network nodes are, for example, manual switches, central and/or decentralized control units and linear actuators with axial flux motors that include decentralized control units or, for example, other actuators used in the system with decentralized control units. Also sensor components can be network nodes.

Mobile devices such as a mobile phone and/or a tablet computer can also be used as manual switches. The network nodes communicate with other network nodes via the network. For example, decentralized control units communicate with other decentralized control units and/or with one or more manual switches.

Another advantage of this example is that individual components of the furniture system can he easily replaced at a later moment. For example, when replacing a linear actuator with a decentralized control unit in the furniture system, only a new registration as a network node in the wireless network is required. There is no need for extensive new cabling in this case. Furthermore, cables often represent a weak point in an electric system, which are susceptible to cable breakage, for example.

A further advantage of this example is that at high voltages in the mains voltage range, especially at DC voltages, strong electric fields can occur in lines carrying these voltages. To avoid the electric fields, shields must be provided, for example, in the form of foil shields with metallic foil or with a metallic net mesh. According to the example described here, the expenditure of time and money for such shielding is minimized because the number of such cables is minimized.

In addition, it is advantageous that the number of network nodes, for example of linear actuators with decentralized control units and/or manual switches, can be easily modified in the furniture system at a later moment. Additional components of this type only need to be registered as network nodes in the network. A limitation of such components, e.g. by a number of physical connectors on a central control unit, is thus avoided.

According to at least one example, the adjustable furniture system further comprises at least one further linear actuator, whereby the at least one and the at least one further linear actuator can be moved synchronously and/or quasi-parallel.

For example, in a table system with two table legs, in each table leg, a linear actuator with one decentralized control unit each is used, one of which acts as master and the other as slave. In a synchronous movement, the slave control unit supplies information about the present height of its associated linear actuator to the master control unit. The master control unit ensures that the linear actuators are brought to the same height and held at the same level, i.e. braking or acceleration of the linear actuators is synchronous. The exchange of information between the slave control unit and the master control unit for the synchronous procedure is carried out in particular via the network modules of the decentralized control units.

In a quasi-parallel movement, the actuators do not supply information about their present height to the central or master control unit. A central or master control unit simultaneously gives the linear actuators the same targets and the linear actuators control their movement to the target position independently. Provided that the linear actuators are controlled identically, the linear actuators move identically.

According to at least one example of the electrically adjustable furniture system, at least two linear actuators of the furniture system are logically combined into at least one actuator group. Each furniture system can thus comprise one or more actuator groups, for example. For example, each linear actuator of the furniture system is always assigned to exactly one actuator group or to none at all. The formation of actuator groups is particularly advantageous, since linear actuators of an actuator group can be adjusted together synchronously and/or quasi-parallel. This is done, for example, depending on an actuation signal which, when requested by a user, signals a desired adjustment of at least one specific actuator group.

An example of an installation method for a linear actuator in a furniture system, wherein the linear actuator comprises at least one axial flux motor having a rotor and at least one motion mechanism and the furniture system comprises a plate arranged substantially horizontally and at least one telescopic column arranged perpendicular to the plate, the method comprises the following steps:

mounting the at least one axial flux motor to the plate or in a foot pail attached to the at least one telescopic column so that a plane of rotation of the rotor of the axial flux motor is arranged parallel to the plate,
mounting the at least one motion mechanism in the at least one telescopic column,
connecting the at least one motion mechanism to the rotor of the at least one axial flux motor.

The substantially horizontally arranged plate is, for example, a table top of a table system or a seating surface of a piece of seating furniture. The disk-like construction of the axial flux motor is particularly suitable for an installation on the plate or in the foot part.

An example of a furniture system arrangement comprises at least one first and at least one second electrically adjustable furniture system corresponding to one of the electrically adjustable furniture systems described above. The linear actuators of the at least one first and the at least one second electrically adjustable furniture system are movable synchronously and/or quasi-parallel.

In this way it is possible, for example, to move a number of electrically adjustable table systems synchronously and/or quasi-parallel. In school classes or conference rooms, for example, it may be desired to adjust several tables together using only one hand control. Thus several tables form a furniture group which can be adjusted synchronously and/or quasi-parallel. In an optional example of such a furniture system arrangement, actuation signals from a manual switch to at least one central and/or decentralized control unit and/or signals based on the actuation signals from at least one decentralized control unit to at least one other decentralized control unit are transmitted via a wireless network.

According to a further example of the furniture system arrangement, the at least one first and the at least one second electrically adjustable furniture system further comprises at least one further linear actuator each. At least one linear actuator of the at least one first furniture system and at least one linear actuator of the at least one second furniture system are logically combined in this configuration to form at least one actuator group. All linear actuators of an actuator group can be moved synchronously and/or quasi-parallel.

All linear actuators that are logically combined to form an actuator group are connected to a control unit, for example. In this context, logically combined means that in an arrangement with at least one central control unit, control signals are sent from the at least one control unit to all linear actuators of the actuator group on the basis of a single actuation signal of the manual switch. In a decentralized arrangement, this means that when the manual switch is actuated, an actuation signal is sent to all decentralized control units of the linear actuators of the actuator group.

Alternatively, in the furniture system arrangement, the decentralized control unit functions, for example, according to the master-slave control concept described above. The actuation signal is then sent from the actuated manual switch to a control unit, the master, which in turn passes the signal of actuation to all slaves connected to the master. The slave control units, if they belong to the selected actuator group, then send a corresponding control signal to their associated linear actuators.

In all cases, an assignment of individual network nodes to corresponding actuator groups is stored in a non-volatile memory of a monitoring entity, for example in the form of a table. The central control unit or one of the decentralized control units, in particular the master, is suitable as the monitoring entity. Alternatively, it is possible that the table with the assignments of the network nodes to corresponding actuator groups is stored in a non-volatile memory of each decentralized control unit. This is particularly advantageous if a master control unit transmits an actuation signal, which signals an actuation request for a specific actuator group, to all connected slave control units. The slave control units only send a control signal to their associated linear actuators if the table shows that the respective slave control unit belongs to the specific actuator group that is affected by the actuation request. In this case, each slave control unit checks its membership of the corresponding actuator groups itself.

Further advantageous examples are described in the attached claims and the following description of design examples using the attached figures. In the figures, identical reference signs are used for elements with essentially the same functionality, but these elements need not be identical in every detail.

### BRIEF DESCRIPTION OF THE DRAWINGS

In the figures:

FIG. 1 shows an electrically adjustable table system according to a first design example,

FIG. 2 shows an electrically adjustable table system according to a second design example,

FIG. 3 shows an axial flux motor,

FIG. 4 shows an axial flux motor mounted on a table top,

FIG. 5 shows an axial flux motor mounted on a telescopic table leg of an electrically adjustable table system,

FIG. 6 shows an electrically adjustable piece of seating furniture according to a first design example,

FIG. 7 shows an electrically adjustable piece of seating furniture according to a second design example,

FIG. 8 shows a rotor and part of a stator of an axial flux motor,

FIG. 9 shows an electrically adjustable bed system arrangement,

FIG. 10 shows an axial flux motel a motor housing in an exploded view,

FIG. 11 shows an insert of the axial flux motor according to FIG. 10, and

FIG. 12 shows the axial flux motor according to FIG. 10 in a sectional view.

### DETAILED DESCRIPTION

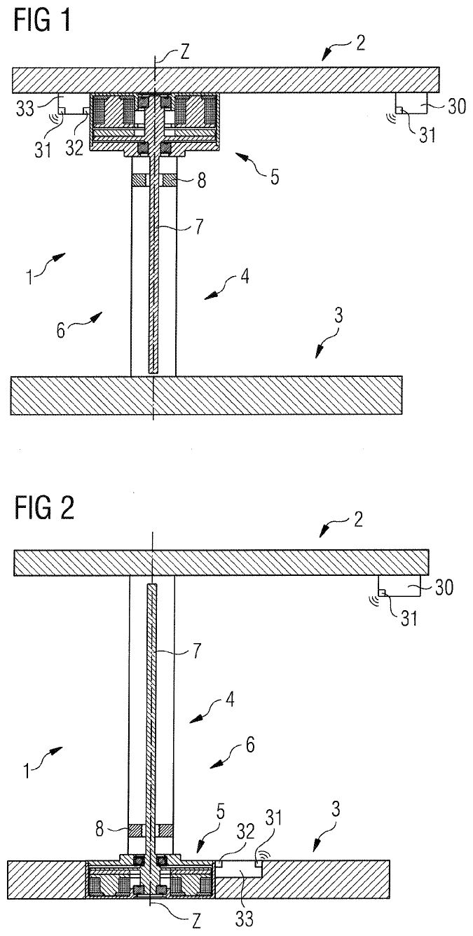

FIG. 1 shows an electrically adjustable table system 1 according to a first design example. FIG. 2 shows an electrically adjustable table system 1 according to a second design example. The table systems 1 in FIG. 1 and FIG. 2 each have a table top 2, a furniture foot 3 and a telescopic table leg 4. Table top 2 and furniture foot 3 are connected to the telescopic table leg 4. Furniture foot 3 stands essentially horizontally on a floor not shown here. The table top 2 is arranged essentially parallel to the furniture foot 3. Table top 2 and furniture foot 3 are each positioned perpendicular with respect to the telescopic table leg 4.

FIG. 1 and FIG. 2 are side views of the electrically adjustable table systems 1, so only one telescopic table leg 4 is shown in each of these illustrations. In fact the table systems 1 can have one, two or more such telescopic table legs.

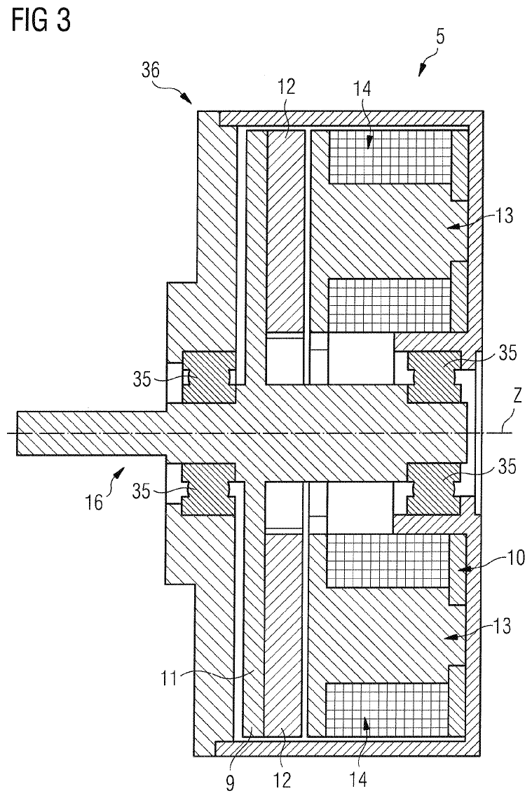

The electrically adjustable table systems 1 in FIG. 1 and FIG. 2 each have an axial flux motor 5. The axial flux motor 5 in FIG. 1 and FIG. 2 is designed to drive a motion mechanism 6 of the electrically adjustable table system 1. The axial flux motor 5 is described in detail with reference to FIG. 3.

According to the first example as shown in FIG. 1 and according to the second example as shown in FIG. 2, motion mechanism 6 consists of a spindle 7 and a nut 8 in which spindle 7 is rotatably mounted. Spindle 7 is set in rotation by the axial flux motor 5. This rotational movement of spindle 7 causes a linear movement of spindle 7 along a central axis Z of the telescopic table leg 4 relative to nut 8. In this way, a height of table top 2 is adjusted along the central axis Z.

According to the first design example as shown in FIG. 1, the axial flux motor 5 is arranged on an underside of table top 2, the underside facing towards the telescopic table leg 4. According to this example, the axial flux motor 5 is therefore a connecting element between the table top 2 and the telescopic table leg 4. The spindle 7 extends in the telescopic table leg 4 in the direction of the furniture foot 3. According to the second example as shown in FIG. 2, the axial flux motor 5 is arranged in the furniture foot 3. Here, spindle 7 extends in the telescopic table leg 4 in the direction of the table top 2.

The first as well as the second example shows the electrically adjustable table system 1 in a fully retracted state with the table top 2 set at a minimum height. In this state the spindle 7 extends over the entire length of the telescopic table leg 4. This way, a maximum stroke for extending the telescopic table leg 4 is possible.

On the underside of the table top 2 in both examples, there is a manual switch 30. The manual switches 30 allows a user to make desired adjustments to the height of the table top 2. The manual switches 30 each have a network module 31, which sends an activation signal when the manual switch 30 is activated.

Furthermore, in both design examples, control units 33 are arranged on the axial flux motors 5. According to the first example as shown in FIG. 1, the control unit 33 is also located on the underside of the table top 2. In the second example, control unit 33 is arranged in the furniture foot 3. Control units 33 each have a network module 31 for receiving the actuation signals. In this way, the control units 33 receive the actuation signals from the manual switches 30 and the control units 33 control the axial flux motors 5 with corresponding control signals. Furthermore, the control units 33 each have a control module 32 to control the axial flux motors 5.

According to both design examples, both the axial flux motors 5 and the control units 33 are supplied with a rectified mains voltage. In these examples, the manual switches 30 are supplied with voltage from rechargeable cells or batteries.

FIG. 3 shows a cross section of an axial flux motor 5, as used, for example, for the adjustable table systems 1 according to FIG. 1 and FIG. 2. The axial flux motor 5 has a rotor 9 and a stator 10. Rotor 9 is perpendicular to the central axis Z and has a rotor disc 11 on which permanent magnets 12 are mounted. Rotor 9 is arranged concentrically with a central axis Z of axial flux motor 5. In FIG. 1 and FIG. 2, the central axis Z of the axial flux motor 5 is congruent with the central axis Z of the telescopic table leg 4. At a central point of the rotor 9, a rotor axis 16 is connected to the rotor 9. The rotor axis 16 is designed to attach a part of a motion mechanism to be driven by the axial flux motor 5. In the design examples as shown in FIG. 1 and FIG. 2, this is a spindle of a spindle-nut system.

The stator 10 is arranged essentially parallel to the rotor 9. Stator 10 and rotor 9 form a layer stack. Stator 10 has several pole pieces 13, each of which is wound with a wire 14. A section plane of FIG. 3 runs centrally through the axial flux motor 5, and in this figure two pole pieces 13 are shown with the wires 14 wound around them. If a current is passed through the wires 14, this creates a magnetic field which, when it is driven so that the magnetic field rotates, causes the rotor 9 to rotate.

To ensure low-friction running of the rotor 9, the rotor axis 16 is rotatably mounted in bearings 35. Rotor 9 and stator 10 are surrounded in this example by a single motor housing 36.

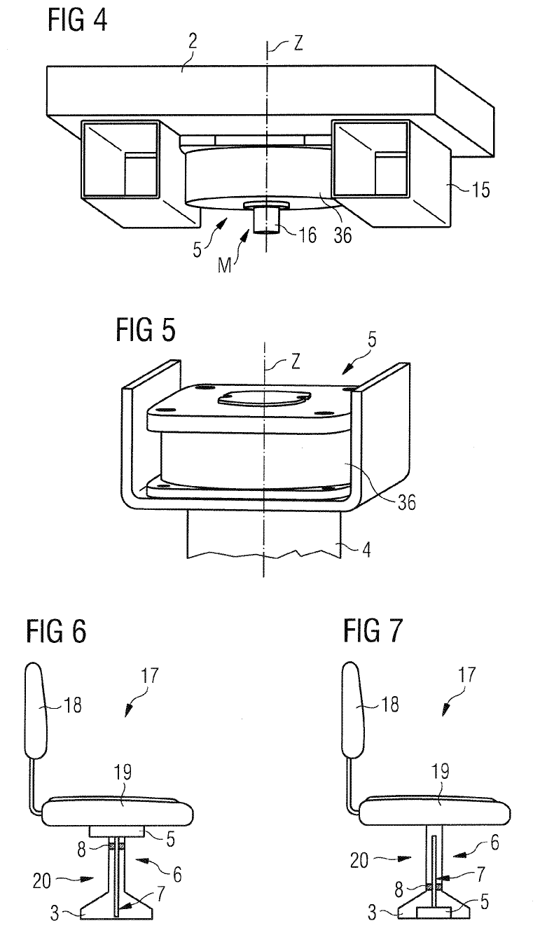

FIG. 4 and FIG. 5 show two different design examples for mounting an axial flux motor 5 on an electrically adjustable table system. FIG. 4 shows a design example in which the axial flux motor 5 is mounted directly via a motor housing 36 of the axial flux motor 5 on a table top 2 of an electrically adjustable table system. Also attached to the table top 2 and located next to the axial flux motor 5 are two metal tubes 15 of a table frame of the electrically adjustable table system in FIG. 4. The axial flux motor 5 has a height along a central axis Z of less than 40 millimeters and the metal tubes 15 have a height of more than 40 millimeters in the same direction. The axial flux motor 5 is thus protected between the metal tubes 15.

Along the central axis Z, a rotor axis 16 protrudes from the axial flux motor 5, which is connected to a rotor of the axial flux motor 5 at a central point of the rotor. For example, a telescopic table leg not shown here is connected to the axial flux motor 5 concentrically to the central axis Z. The telescopic table leg, for example, has a spindle corresponding to spindle 7 as shown in FIG. 1 or FIG. 2, which is torque-proof connected to the rotor axis 16. Alternatively, the rotor axis 16 itself can be extended so that it functions as a spindle. During assembly, this spindle is then pushed into a telescopic table leg.

FIG. 5 shows an example of how to mount an axial flux motor 5 on an electrically adjustable table system, wherein the axial flux motor 5 is mounted on a telescopic table leg 4. The axial flux motor 5 and telescopic table leg 4 form a unit in this example. This unit consisting of axial flux motor 5 and telescopic table leg 4 is suitable, for example, for being attached to the underside of a table top of an electrically adjustable table system.

Both the examples of mounting an axial flux motor 5 on an electrically adjustable table system shown in FIG. 4 and in FIG. 5 are suitable for the table system shown in FIG. 1. Both the example shown in FIG. 4 and the example shown in FIG. 5 can be used with axial flux motor 5 as described in FIG. 3.

FIG. 6 and FIG. 7 show a first and a second example of an electrically adjustable piece of seating furniture 17. The electrically adjustable piece of seating furniture 17 consists of a backrest 18, a seat 19 and a chair leg 20. The chair leg 20 is attached to a lower side of the seat 19. A furniture foot 3 is attached to a lower end of the chair leg 20. The chair leg 20 is telescopic and surrounds a motion mechanism 6 which allows the chair leg 20 to be extended or retracted.

The motion mechanism 6 in this example consists of a spindle 7 and a nut 8, while the motion mechanism 6 is driven by an axial flux motor 5. The moving of the motion mechanism 6 with the axial flux motor 5 is analogous to the moving of the motion mechanism as shown in FIG. 1 and FIG. 2.

In the design example shown in FIG. 6, the axial flux motor 5 is mounted on the underside of the seat 19. In the design example shown in FIG. 7, the axial flux motor 5 is arranged in the furniture foot 3. Not shown in FIG. 6 and FIG. 7 are manual switches and control units for controlling the axial flux motors 5. The control of the axial flux motors 5 is, for example, analogous to the control of the axial flux motors 5 of the electrically adjustable table systems 1 as shown in FIG. 1 and FIG. 2.

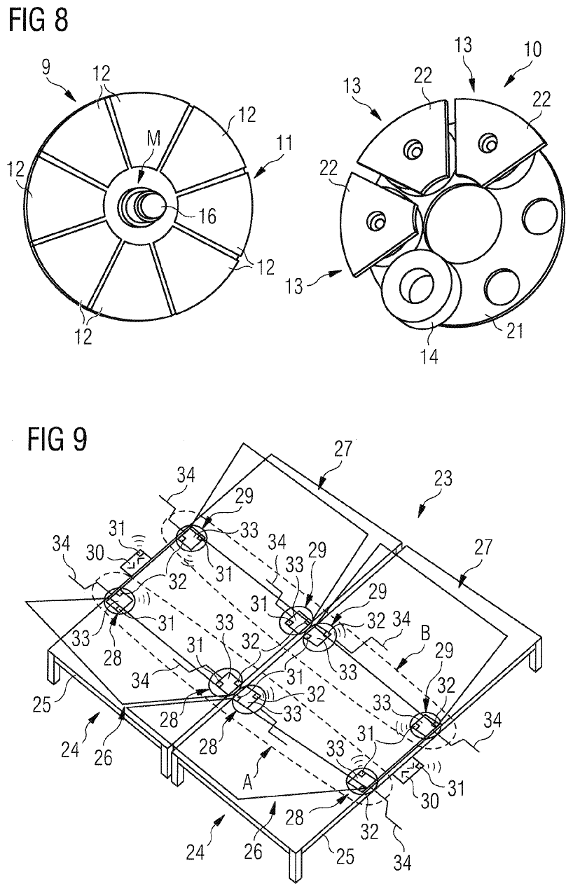

FIG. 8 shows a rotor 9 and part of a stator 10 of an axial flux motor 5 as used in the previously described examples according to FIG. 1 to FIG. 7.

Rotor 9 consists of a rotor disc 11 on which a total of eight permanent magnets 12 are mounted. The permanent magnets 12 are designed as equally sized circle segments. At the center M of rotor 9, a rotor axis 16 is arranged perpendicular to a circular plane of rotor 9. The permanent magnets 12 are arranged on the rotor disc 11 in such a way that there is an air gap of about 2 to 7 millimeters between them.

Like the rotor 9, the stator 10 is circular in shape. The stator 10 has a support plate 21 on which windings wound with a wire 14 are arranged. T-shaped pole pieces 13 are inserted into the windings. The support plate 21 can also be called a stator ring. For illustrative purposes, only three of a total of six attachable pole pieces 13 are shown in FIG. 8. The pole pieces 13 consist of a soft magnetic material, for example a silicon-iron (SiFe) alloy, a nickel-iron (NiFe) alloy or a cobalt-iron (CoFe) alloy. On a side of the pole pieces 13 facing away from the support plate 21, the pole pieces 13 have metal plates 22 which are designed in the form of circle segments and, together with a fastening part of the pole pieces 13, form the T-shaped profile. The pole pieces 13 are arranged on the support plate 21 in such a way that there are air gaps of 2 to 7 millimeters between the circular sector-shaped metal plates 22.

If current is conducted through the wires 14, the wound wires 14 generate a magnetic field which is amplified by the pole pieces 13. The wound wires 14 are each supplied by a three-phase alternating current in such a way that a rotating magnetic field is generated at the stator 10. The rotor 9 is located in the axial flux motor 5 so that the permanent magnets 12 face towards the metal plates 22 and that the permanent magnets 12 are parallel to the metal plates 22 of the pole pieces 13, whereby the rotating magnetic field generated by the stator 10 sets the rotor 9 in rotation.

The stator 10 shown in FIG. 8 is particularly suitable for arranging power electronics and control electronics on a rear side of the support plate 21, i.e. the side facing away from the pole pieces 13, the power electronics being arranged to supply the stator with a supply voltage and the control electronics being arranged to control the power electronics and apply the supply voltage to the respective wires 14. This ensures a high degree of compactness of the axial flux motor 5. Power electronics and control electronics are, for example, part of a control module of a control unit of the axial flux motor.

The stator 10, in particular the individual parts of the stator 10, such as the support plate 21 and the pole pieces 13, can also be made of a solid material consisting of iron or an iron alloy, for example according to one of the above-mentioned iron alloys. In particular, the metal plates 22 of the pole pieces 13 are made of this solid material. The material has, for example, eddy current properties which are designed to extract energy, in particular braking energy, from the axial flux motor 5.

The choice of the material as a solid material and especially as a material with special eddy current properties results in higher iron losses during operation of the axial flux motor than when the stator is formed with stacked and/or insulated metal sheets with rather low electrical conductivity, which are usually used in electric motors. As a result, the axial flux motor 5 develops a braking effect under load, which in turn acts as a braking force to prevent slipping of a linear actuator, especially of a linear actuator at standstill. However, slipping during a downward movement, i.e. in the direction of an applied external load, can also be prevented or reduced by the braking effect. This will be described in more detail below.

As a material a mild steel can be used for example, which is generally cheaper than special layered materials. Although steels, especially mild steels, are also soft magnetic materials, they are mainly used as materials for constructions, so that the mechanical properties are the main focus. As magnetic materials they are less suitable in conventional electromotive applications. Additives such as carbon or chromium usually significantly impair the magnetic properties. When higher demands are placed on the magnetic values, conventional steel qualities therefore quickly reach their limits.

Motors with stators made of these unfavorable materials have a high power loss and therefore become very hot during operation, especially in continuous operation. On the other hand, the material costs are advantageously low.

Considering the demands on motors for linear actuators in furniture, continuous operation is not necessary. In addition, the power loss depends on the speed. Especially when using an axial flux motor with direct drive, the speed is significantly lower in comparison to motors with gear units. In combination, therefore, the higher power loss of motors with stators with low-cost structural steels may well be acceptable.

It should also be taken into account that furniture actuators, e.g. when used in a table system, should not slip at standstill due to the weight pressing on the table top. This can be prevented by a braking mechanism. This could be, for example, a mechanical brake, a braking force caused by the air gaps or a small spindle pitch, as already described elsewhere in this application. The weight pressing on the table top, for example, should also not cause the actuator to accelerate while moving down. The additional energy from the weight pressing on the table top should be dissipated.

This can be achieved, for example, by the braking mechanisms mentioned above, or by using the iron losses of inherently inferior stator materials. In principle, the energy that causes the actuator to accelerate during downward travel can at least partially be avoided by the iron losses. The iron losses are basically converted into heat losses.

The heat losses or iron losses are caused by the alternating magnetic fields in every electrical machine. A distinction is made between eddy current losses and hysteresis losses.

Usually, eddy current losses are greatly reduced by dividing the iron into stacked and insulated sheets (lamination). With the proposed use of a solid material, no such reduction occurs.

The electrical conductivity of the materials used affects the eddy currents. The higher the conductivity, the greater the eddy currents and thus the eddy current losses, especially since no metal sheets are used.

For example, the solid material has an electrical conductivity of more than 2 MS/m, in particular more than 10 MS/m. This means that the electrical conductivity is higher than that of commonly used materials. Mild steel has an electrical conductivity of approximately 10.5 MS/m and is therefore suitable as a material for the components of stator 10.

FIG. 9 shows a bed system arrangement according to a design example of the invention. The bed system arrangement 23 consists of two bed systems 24 of essentially the same design. The bed systems 24 each comprise a bed frame 25 and each comprise an adjustable head section 26 and an adjustable foot section 27.

If the bed system arrangement 23 is used as a double bed system, for example with a single continuous double bed mattress, it is desirable to adjust the head sections 26 of the individual bed systems 24 together. The same applies to the foot sections 27 of bed systems 24.

To adjust the head sections 26 and foot sections 27, the bed systems 24 each have two head section actuators 28 and two foot section actuators 29. The head section actuators 28 are designed to adjust the head sections 26 of the respective bed systems 24. The foot section actuators 29 are designed to adjust the foot sections 27 of the respective bed systems 24. Both the head section actuators 28 and the foot section actuators 29 each comprise an axial flux motor as shown in the Figures described above.

In order to allow the head sections 26 and the foot sections 27 to be adjusted synchronously and/or quasi-parallel, the four head section actuators 28 form a first actuator group A and the four foot section actuators 29 form a second actuator group B. In order to adjust the head sections 26 and the foot sections 27, a manual switch 30 is attached to each of the two bed systems 24. The manual switches 30 each have a network module 31, via which an actuation signal is sent out when one of the manual switches 30 is actuated. The head section actuators 28 and the foot section actuators 29 each comprise a decentralized control unit 33. The control units 33 each have a network module 31 and a control module 32. Via the network modules 31, the manual switches 30 or the actuators 28, 29 establish a connection to a wireless network, via which the manual switches 30 can communicate with the actuators 28, 29 or the actuators 28, 29 can communicate with each other. Each entity that includes a network module 31 and can thus communicate via the wireless network represents a network node in the network. The control modules 32 are used to perform technical control tasks of the axial flux motors of the actuators 28, 29 and generate control signals with which the actuators 28, 29 are controlled.

The network module 31 of one of the control units 33, which functions as the master control unit, receives the actuation signal from the manual switch 30 and passes it on to the respective decentralized control units 33, which function as slave control units to the master control unit. If an actuation for adjusting, for example the head section 26, is registered on one of the manual switches 30, the corresponding manual switch 30 sends the actuation signal via the network module 31 of the manual switch 30 to a control unit 33, wherein the control unit 33 is connected to the manual switch 30 as a master control unit. This master unit then forwards the actuation signal, unchanged or modified, to all actuators of the first actuator group A, i.e. to all head section actuators 28. At all head section actuators 28, the actuation signal is received by the network modules 31 and forwarded to the control modules 32 of the control units 33 of the head section actuators 28. These control modules 32 activate the axial flux motors of the head section actuators 28 to adjust the head sections 26 synchronously or quasi-parallel.

Alternatively, the network modules of all slave control units of actuators 28, 29 receive the forwarded unchanged or modified actuation signal from the master control unit. The forwarded actuation signal contains information regarding the actuator group to be adjusted. The slave control units then evaluate the forwarded actuation signal with regard to the actuator group which is to be adjusted. If a slave control unit recognizes that it belongs to the actuator group which is to be adjusted, the control module 32 of the corresponding slave control unit activates the associated axial flux motor. The evaluation with regard to the actuator group can be carried out, for example, by a table comparison with a table in which the assignments of the individual actuators to actuator groups A, B are stored.

According to the example as shown in FIG. 9, all actuators 28, 29 are connected via supply connections 34 to a mains supply with a voltage of 230 V. Actuators 28, 29 each include a rectifier circuit to rectify the mains voltage of 230 V. The rectified mains voltage is used to supply power electronics of the axial flux motors of actuators 28, 29. According to this example, the control units 33, in particular the network modules 31 and control modules 32 of the actuators 28, 29, are also supplied with the rectified mains voltage.

According to an alternative design example, a rectifier is installed in a central control unit to which the actuators 28, 29 are electrically connected. In this case, there are cable connections between the central control unit and the actuators 28, 29, the cable connections being used to supply power to the actuators 28, 29 and to transmit the control signals. According to this alternative design example, the transmission of the actuation signals is also carried out via the wireless network. The power supply of a centralized or decentralized control unit can also be provided by batteries or rechargeable cells in another design example.

Alternatively, it is also possible to send the actuation signal to a central control unit, not shown in this figure, which in turn sends a control signal to all actuators of an addressed actuator group to move their axial flux motors accordingly.

In another alternative, each bed system 24 includes a central control unit that is arranged to receive an actuation signal from both manual switches 30. The central control units of the respective bed system 24 then transmit a control signal to all actuators of the corresponding actuator group of the respective bed system 24 in order to control the corresponding axial flux motors.

When setting up or configuring such a bed system arrangement 23, it is possible to form arbitraty actuator groups with different built-in actuators 28, 29. For example, it may be desired to adjust the head sections 26 of the two bed systems 24 together, but to adjust the foot sections 27 independently. In this case it is possible to combine the four head section actuators 28 to form a first actuator group and to combine the two foot section actuators 29 of a bed system 24 to form a further actuator group each, so that two foot section actuators 29 of a bed system 24 move the corresponding foot section 27 evenly. It is also possible to disband these actuator groups again or to logically remove individual actuators 28, 29 from the actuator groups.

Furthermore, the wireless network can be used to download actuator firmware to the individual network nodes, especially the network nodes of the actuators, or to send it to the corresponding actuators. It is also possible to use the wireless network to upload status information, such as version numbers, error statuses and statistical data to a control entity, for example a computer or one of the control units that acts as a monitoring entity of the system.

The wireless network features described here can also be used analogously in a wired network or bus system, such as a LIN-bus.

The control of the actuators or groups of actuators described with respect to FIG. 9 can also be used in the same way for table system arrangements with electrically adjustable table systems, as described with respect to FIG. 1 and FIG. 2, or for seating furniture arrangements with electrically adjustable pieces of seating furniture, as described with respect to FIG. 6 and FIG. 7.

In particular for table system arrangements or seating furniture arrangements it is also possible to form groups of pieces of furniture in an arrangement in which more than two table systems or pieces of seating furniture are used. For example, it may be desirable to adjust a plurality of table systems of an assembly of such table systems together while leaving other table systems of the assembly at standstill.

Furthermore, when configuring such an arrangement it is possible to logically replace individual pieces of furniture of a furniture group as well as individual actuators of an actuator group. Furthermore, it is possible to register one or more manual switches as network nodes in the network or to remove them from the network. Individual or several manual switches can be used to control individual actuator groups and/or to control individual furniture groups.

Such setup and/or configuration can be done using a computer or mobile device, for example a mobile phone or tablet computer. The configuration information is then sent as a data record to the respective network nodes. This is called a configuration download.

Each network node may communicate via Bluetooth and/or a wireless local area network (WLAN) and/or another wireless communication protocol.

The communication between the network nodes is designed as master-slave communication, for example. In such master-slave communication, one of the network nodes, for example a central control unit or one of the decentralized control units, takes over the central control of the entire network. In such a master network node, the configurations of the actuator groups and/or the furniture groups, for example, are stored on a non-volatile memory.

The electrically adjustable table systems 1 according to FIG. 1 and FIG. 2, the electrically adjustable piece of seating furniture 17 according to FIG. 6 and FIG. 7 and the bed systems 24 according to FIG. 9 are all examples of electrically adjustable furniture systems. Features described with respect to the individual Figures can also be used in a similar way for other electrically adjustable furniture systems.

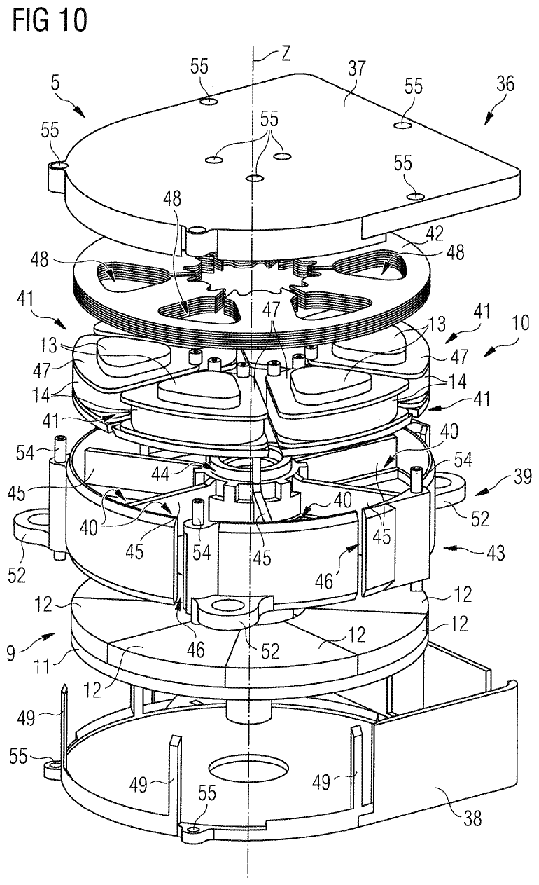

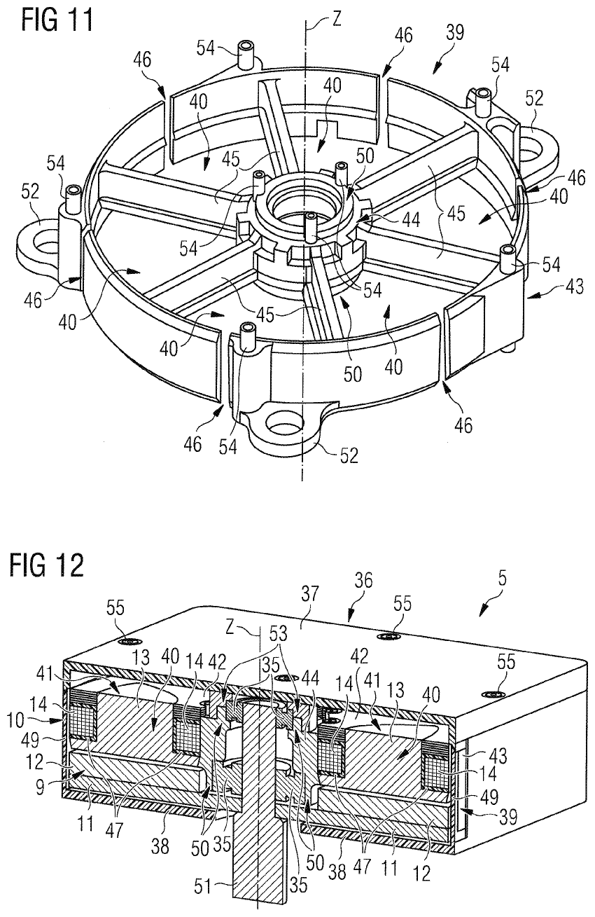

FIG. 10 to FIG. 12 show an example of an axial flux motor 5, as it can be used, for example, in the electrically adjustable table systems 1 described above, the electrically adjustable piece of seating furniture 17, and the bed system 24. FIG. 10 shows an exploded view of the axial flux motor 5, FIG. 11 shows a metallic insert of the axial flux motor 5, and FIG. 12 shows a sectional view of the axial flux motor 5 as shown in FIG. 10.

The axial flux motor 5 has a motor housing 36, which in this example comprises an upper motor cover 37, a lower motor cover 38 and an insert 39. The upper and lower motor covers 37, 38 are made of a plastic material in this example. In this way a low weight of the axial flux motor 5 is achieved. In this example, the insert 39 is made of metal. In this way, a high rigidity and stability of the axial flux motor 5 is achieved.

In the motor housing 36 there are layers of a rotor disc 11, on which permanent magnets 12 are mounted, the insert 39, which has receiving areas 40 for stator teeth 41, and a closing element 42 for closing a magnetic field. Both the rotor disc 11 with the permanent magnets 12 and the stator teeth 41 and the closing element 42 are designed in such a way that they are at least partially surrounded by the insert 39. According to this design example, the rotor disk 11 is adjacent to the lower motor cover 38 and the closing element 42 is adjacent to the upper motor cover 37. Alternatively, of course, a reverse order of the layers with respect to the motor covers 37, 38 is also possible.

In the design example shown here, the rotor disk 11 has several circular sector-shaped permanent magnets 12. Alternatively, a ring magnet can also he arranged on the rotor disk 11, which is connected to the rotor disk 11. The ring magnet consists of only one ferrite magnet, which has several poles, i.e. where north and south poles alternate.

The insert 39 has an outer ring 43 and an inner ring 44. The outer and inner rings 43, 44 are each concentric with each other around a central axis Z of the axial flux motor. The outer ring 43 and the inner ring 44 are connected by bridges 45. According to this design example, the insert 39 has a total of six bridges 45, which are arranged at equal distances from each other. The spaces between the bridges 45 and the rings 43, 44 represent the receiving areas 40 for the stator teeth 41.

The outer ring 43 has several gaps 46 in its circumference, which divide the outer ring 43 into several parts. According to this design example, the outer ring 43 has a total of six gaps 46, so the circumference of the outer ring 43 is divided into six parts. Each of these six parts is connected to the inner ring 44 by one bridge 45. The gaps 46 prevent or reduce the occurrence of eddy currents in the axial flux motor 5.

The stator teeth 41 are designed in such a way that they can be inserted in the circular sector-shaped receiving areas 40. The stator teeth 41 each have a pole piece 13, the pole piece 13 being T-shaped in the profile, wherein each pole piece 13 is partially surrounded by a wire 14. The wire 14 is wound onto a bracket 47, which is U-shaped in profile and can be placed on the pole piece 13 together with the wound wire 14. This can be seen in particular in FIG. 12.

The design of the stator teeth 41 and the bridges 45 allows easy insertion of the stator teeth 41 into the insert 39, thus enabling quick and uncomplicated assembly of the axial flux motor 5. The stator teeth 41 can be inserted into the insert 39 from a first side, the rotor disk 11 can be inserted into the insert 39 from a second side opposite the first side.

The pole pieces 13 protrude over the support 47 on the side facing the closing element 42, so that the closing element 42 can be fitted onto the protruding ends of the pole pieces 13 with appropriate recesses.

The lower motor cover 38 and the upper motor cover 37 do not completely close off the axial flux motor 5. The lower motor cover 38 has recesses 48 into which the outer ring 43 of the insert 39 is fitted. The lower motor cover 38 has lugs 49 pointing towards the upper motor cover 37, which are inserted into gaps 46 of insert 39 when the motor housing 36 is assembled. The rotor disk 11 with the permanent magnets 12, the stator teeth 41, and the closing element 42 are thus completely enclosed by the lower motor cover 38, the upper motor cover 37, and the outer ring 43 of insert 39. In this way, the interior of the axial flux motor 5 is protected from environmental influences.

The inner ring 44 of the insert 39 has 2 bearing points 50, at each of which a bearing 35 is arranged. A motor shaft 51 of the axial flux motor 5 is supported in the bearings 35. In this way, the insert 39 serves to dissipate the force from the motor shaft 51 via the bearing points 50 to mounting points 52 of the axial flux motor 5.

In an area of the bearing point 50, which is adjacent to the upper motor cover 37, the inner ring 44 has a socket 53 pointing outwards from the central axis Z, which accommodates a corresponding counterpart of the upper motor cover 37. The insert 39 is thus mounted on the upper motor cover. In addition, the insert 39 is held by the lugs 49 of the lower motor cover 38.

For assembly of the arrangement shown here, the insert 39 has three sleeves 54 on the inner ring 44 and five sleeves 54 on the outer ring 43, each of which is arranged parallel to the central axis Z and has an internal thread. Upper and lower motor covers 37, 38 have corresponding holes 55 in which the sleeves 54 engage and through which the upper and lower motor covers 37, 38 can be fixed to the insert 39 by means of screws. The upper motor cover 37, the lower motor cover 38 with the lugs 49 and the outer ring 43 of the insert form the motor housing 36 which is closed off from the outside and thus protects the interior of the axial flux motor 5 from environmental influences.

The parts of the axial flux motor 5 not described in detail here may be similar to the axial flux motors described above. Furthermore, features of the design examples described in FIG. 1 to FIG. 12 can be combined in any suitable way.

1. A linear actuator for a furniture system, comprising at least one axial flux motor (5) having a rotor (9), and at least one motion mechanism (6), wherein the motion mechanism (6) is adapted to cause a linear movement of the linear actuator.

2. The linear actuator according to claim 1, wherein the motion mechanism (6) comprises at least one spindle-nut system (7, 8) mounted on a central axis (Z) of the rotor (9), which is arranged to cause the linear movement of the linear actuator upon rotation of the rotor (9).

3. The linear actuator according to claim 2, wherein the spindle-nut system (7, 8) comprises a spindle (7) having an external thread with a thread pitch of less than 5 millimeters per revolution.

4. The linear actuator according to any of the previous claims, arranged to be driven by the axial flux motor at a speed in a range from 500 to 2000 revolutions per minute, in particular 500 to 1500 revolutions per minute.

5. The linear actuator according to one of the previous claims, wherein the at least one axial flux motor (5) is adapted to be supplied with a voltage rectified from a mains voltage, in particular from a mains voltage of 230 volts or 115 volts.

6. The linear actuator according to one of the previous claims, wherein the at least one axial flux motor (5) further comprises at least one stator (10), wherein a plane of rotation of the rotor (9) is arranged parallel to a main plane of extension of the stator (10).

7. The linear actuator according to claim 6, wherein power electronics and/or control electronics of the at least one axial flux motor (5) are arranged on the at least one stator (10).

8. The linear actuator according to claim 6 or 7, wherein a support plate (21) of the stator and/or pole pieces (13) of the stator (10) are formed from a solid material which consists of iron or an iron alloy and which has eddy current properties which are set up to extract energy, in particular braking energy, from the at least one axial flux motor (5).

9. The linear actuator according to claim 8, wherein the solid material has an electrical conductivity of more than 2 MS/m, in particular more than 10 MS/m.

10. The linear actuator according to claim 8 or 9, wherein the solid material consists of mild. steel.

11. The linear actuator according to any of the previous claims, wherein the rotor (9) has a diameter of less than 120 millimeters.

12. The linear actuator according to one of the previous claims, wherein a design of the at least one axial flux motor (5) is selected such that a torque ripple of the at least one axial flux motor (5) prevents slipping of the linear actuator.

13. The linear actuator according to one of the previous claims, wherein the axial flux motor (5) has a motor housing (36), the motor housing (36) comprising an upper motor cover (37), a lower motor cover (38), and an insert (39), wherein the insert (39) comprises a continuous inner ring (44) and an outer ring (38) connected to the inner ring (44) via bridges (45), wherein the outer ring has multiple gaps, the insert (39) comprises receiving areas (40) for stator teeth (41), the inner ring (44) has at least two bearing points (50) for receiving bearings (35) for a motor shaft (51), and the insert (39) is arranged to conduct a force from a motor shaft (51) to mounting points (52) of the motor housing (36).

14. The linear actuator according to claim 13, wherein the receiving areas (40) are designed in the shape of a circular sector.

15. The linear actuator according to one of claim 13 or 14, wherein a receiving area (40) is respectively formed by two bridges (45) and a segment of the outer ring (43).

16. The linear actuator according to one of claims 13 to 15, wherein the receiving areas are open to one side.

17. The linear actuator according to one of claims 13 to 16, wherein at least one of the upper or the lower motor cover (37, 38) has lugs (49) which are received m the multiple gaps of the outer ring (43).

18. The linear actuator according to any one of claims 13 to 17, wherein the insert (39) comprises or consists of a metallic material and the upper and lower motor covers (37, 38) comprise or consist of a plastic material.

19. An electrically adjustable furniture system, in particular a table system (1), a piece of seating furniture (17) or a bed system (24), comprising at least one linear actuator according to one of the previous claims.

20. The electrically adjustable furniture system according to claim 19, further comprising at least one mount for a substantially horizontally arranged plate and at least one telescopic column arranged substantially perpendicular to the plate, the telescopic column having a foot part, wherein the at least one axial flux motor (5) is arranged on the plate or in the foot part in such a way that a plane of rotation of the rotor (9) is parallel to the plate and the at least one motion mechanism (6) is arranged in the at least one telescopic column.

21. The electrically adjustable furniture system according to one of claim 19 or 20, wherein the at least one axial flux motor (5) has a maximum height of 40 millimeters in a direction perpendicular to the plane of rotation of the rotor (9).

22. The electrically adjustable furniture system according to one of claims 19 to 21, wherein the at least one axial flux motor (5) is adapted to drive the at least one motion mechanism (6) directly, in particular without a gear unit.

23. The electrically adjustable furniture system according to one of claims 19 to 22, further comprising at least one manual switch (30) and at least one control unit (33), wherein the at least one manual switch (30) is arranged to send an actuation signal to the at least one control unit (33) upon actuation of the manual switch (30) by a user and wherein the at least one control unit (33) is arranged to send a control signal to the at least one linear actuator based on the at least one actuation signal.

24. The electrically adjustable furniture system according to claim 23, wherein the at least one manual switch (30) and/or the at least one control unit (33) is arranged to perform communication between the manual switch (30) and at least one control unit (33) and/or communication between the at least one control unit (33) and at least one further control unit via a wireless network.

25. The electrically adjustable furniture system according to claim 24. wherein the at least one control unit (33) comprises a network module (31) and a control module (32), wherein the network module (31) is arranged to communicate with other network modules via the wireless network and the control module (32) is arranged to send the control signal to the at least one linear actuator.

26. The electrically adjustable furniture system according to one of claims 23 to 25, wherein the at least one linear actuator and/or the at least one control unit (33) is arranged to be supplied with a voltage rectified from a mains voltage, in particular from a mains voltage of 230 volts or 115 volts.

27. The electrically adjustable furniture system according to one of claims 19 to 26, further comprising at least one further linear actuator, wherein the at least one and the at least one further linear actuator can be moved synchronously and/or quasi-parallel.

28. The electrically adjustable furniture system according to claim 27, wherein at least two linear actuators are logically combined to at least one actuator group (A, B).

29. An installation method for a linear actuator in a furniture system, wherein the linear actuator comprises at least one axial flux motor (5), the at least one axial flux motor (5) having a rotor (9) and at least one motion mechanism (6), and the furniture system comprises a plate arranged substantially horizontally and at least one telescopic column arranged perpendicular to the plate, the installation method comprising the following steps:
mounting the at least one axial flux motor (5) to the plate or in a foot part attached to the at least one telescopic column so that a plane of rotation of the rotor (9) of the at least one axial flux motor (5) is arranged parallel to the plate,
mounting the at least one motion mechanism (6) in the at least one telescopic column, and
connecting the at least one motion mechanism (6) to the rotor (9) of the at least one axial flux motor (5).

30. A furniture system arrangement comprising at least one first and at least one second electrically adjustable furniture system according to one of claims 19 to 28, wherein the linear actuators of the at least one first and the at least one second electrically adjustable furniture system can be moved synchronously and/or quasi-parallel.

31. The furniture system arrangement according to claim 30, wherein the at least one first and the at least one second furniture system further each comprise at least one further linear actuator, wherein at least one linear actuator of the at least one first furniture system and at least one linear actuator of the at least one second furniture system are logically combined to form at least one actuator group (A, B), and wherein all linear actuators of an actuator group (A, B) can be moved synchronously and/or quasi-parallel.
